(19) United States
(12) Patent Application Publication
(10) Pub. No.: US 2013/0054016 A1
(43) Pub. Date: Feb. 28, 2013

(54) USING CONSUMER PROFILE INFORMATION IN VENDING AND OTHER UNATTENDED RETAIL

(71) Applicants: James M. Canter, Austin, TX (US); William A. Munck, McKinney, TX (US)

(72) Inventors: James M. Canter, Austin, TX (US); William A. Munck, McKinney, TX (US)

(73) Assignee: CRANE MERCHANDISING SYSTEMS, INC., Bridgeton, MO (US)

(21) Appl. No.: 13/598,357

(22) Filed: Aug. 29, 2012

Related U.S. Application Data
(60) Provisional application No. 61/528,629, filed on Aug. 29, 2011.

(51) Int. Cl. G06F 17/00

(52) U.S. Cl. 700/237

(57) ABSTRACT

Consumer profile information is received wirelessly (NFC, Bluetooth, etc.) from a user device at the communications interface for a vending machine, and stored at least temporarily within the vending machine. The current vend transaction with the consumer carrying the user device is then altered based upon the received consumer profile information, to block product sales containing relevant food allergens, offer discounts tailored to the particular consumer, or enforce parental controls, among other possible personalizations of the consumer experience during the vend transaction.

### CROSS-REFERENCE TO RELATED APPLICATIONS

This application claims priority to U.S. Provisional Patent Application Ser. No. 61/528,629 entitled “USING CONSUMER PROFILE INFORMATION IN VENDING AND OTHER UNATTENDED RETAIL” and filed on Aug. 29, 2011. The content of the above-identified patent document is incorporated herein by reference.

### TECHNICAL FIELD

The present application relates generally to employing consumer profile information in connection with unattended retail transactions and, more specifically, to employing consumer profile information in vending machines.

### BACKGROUND

Vending machines offer unattended sales of commodities such as snacks, canned or bottled beverages, or any of a variety of other articles. Historically vending machines have been placed into service in the field as unattended points of sale with little control over how they operate with regards to specific consumers. Consumer interaction with vending machines has largely been limited to anonymous purchase by the consumer of products in isolated sequences of transactions, without customization for the individual characteristics or preferences of the particular consumer involved in the transaction.

Within Internet retail sales, on the other hand, rich consumer profile information (including transaction history and even browsing history) is often used. Similar use of consumer profile information in vending, however, has generally not been viable due to—among other reasons—the limited processing power of most vending machine controllers (VMCs), the minimal data storage normally available within vending machines, and the general lack of connectivity between vending machines and external resources.

There is, therefore, a need in the art for improved use of consumer profile information within vending machines.

### SUMMARY

Consumer profile information is received wirelessly (NFC, Bluetooth, etc.) from a user device at the communications interface for a vending machine, and stored at least temporarily within the vending machine. The current vend transaction with the consumer carrying the user device is then altered based upon the received consumer profile information, to block product sales containing relevant food allergens, offer discounts tailored to the particular consumer, or enforce parental controls, among other possible personalizations of the consumer experience during the vend transaction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified diagram of a network including a vending machine that may utilize consumer profile information received from a user device to alter a vend transaction according to one embodiment of the present disclosure;

FIG. 2 is a simplified perspective view illustrating the physical structure of a vending machine that may utilize consumer profile information to alter a vend transaction received from a user device according to one embodiment of the present disclosure;

FIG. 3 is a block diagram of selected electrical and electronic components forming at least part of the control system within the vending machine of FIG. 2; and

FIG. 4 is a high level process flow diagram for a portion of a vend transaction employing consumer profile information received from a user device to alter a vend transaction according to one embodiment of the present disclosure.

### DETAILED DESCRIPTION

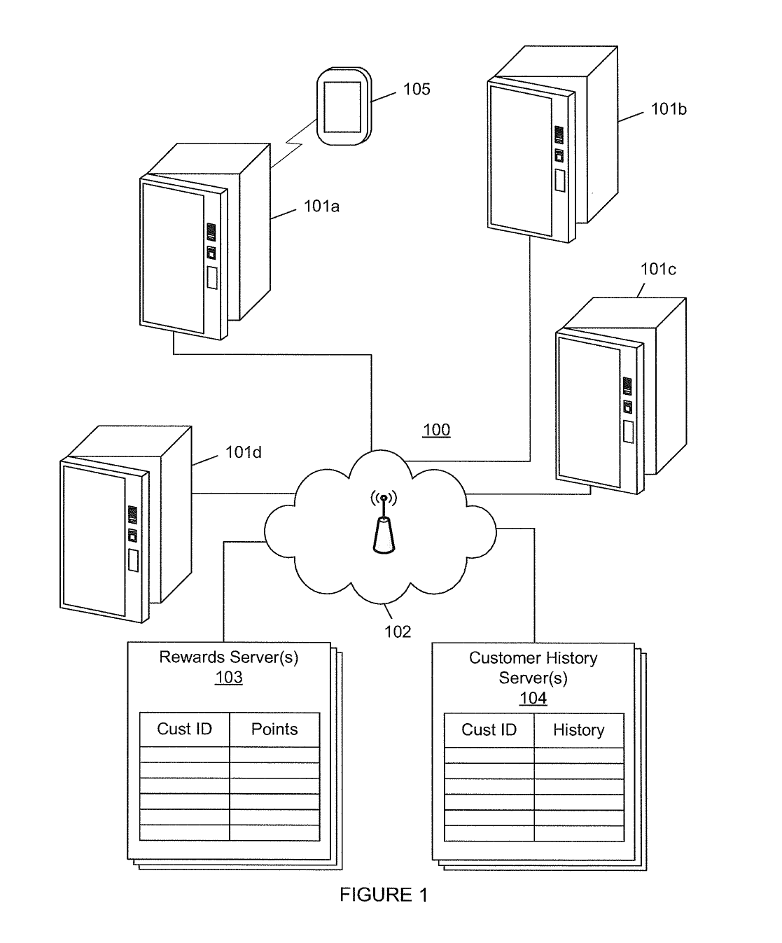

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine system.

During a vend transaction, consumer profile information is received from a smart phone or similar user device at a vending machine through near field communication or a similar wireless data exchange, to personalize the consumer experience at the vending machine based on an establish consumer profile stored in the smart phone. The consumer profile should include relevant medical information such as food allergies (peanuts, gluten, or the like) or other medical conditions (diabetes, high blood pressure, etc.), enabling the vending machine to, for example, prevent vending of foods containing a specific allergen. Other constraints or customizations of a vend transaction based on the received consumer profile information are also enabled, such as enforcement of parental controls, discount offers tailored to the consumer's age, gender, or personal preferences, and loyalty program points redemption or augmentation as part of the vend transaction.

FIG. 1 is a simplified diagram of a network including a vending machine that may utilize consumer profile information received from a user device to alter a vend transaction according to one embodiment of the present disclosure. Network 100 includes a plurality of vending machines 101a through 101d in the exemplary embodiment, each coupled to a data communications system 102. Data communications system 102 may be implemented in a known manner, such as by utilizing Internet Protocol (IP) and/or HyperText Transmission Protocol (HTTP) communications over the Internet, secured by authentication and encryption processes to create a Virtual Private Network (VPN). Access to the data communications system 102 by the vending machines 101a through 101d may be through wireless communications, wired communications or both, utilizing known IP and/or HTTP access and communication methods. Through data communications system 102, vending machines 101a-101d may access and retrieve data stored on servers 103 and 104 for the operator of the vending machines, as described in further detail below.

Vending machines 101a-101d are also configured to wirelessly communicate with a user device 105, which is preferably a “smart phone” or the like (e.g., a touchscreen tablet, an electronic wallet, etc.). Communications between user device 105 and one of vending machines 101a-101d may utilize near field communication (NFC), Wi-Fi (IEEE 802.11) communication, Bluetooth communication, or any other suitable wireless communications protocol. Consumer profile information stored on the user device 105 is received by such wireless communications at one of vending machines 101a with which the consumer has initiated a vend transaction. That consumer profile information is employed at the vending machine 101a to personalize the consumer experience for the vend transaction, in one or more of the manners described below.

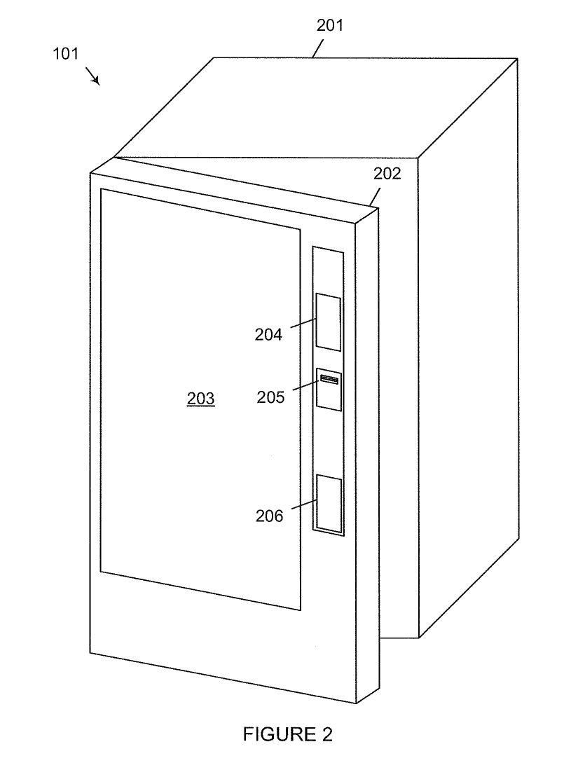

FIG. 2 is a simplified perspective view illustrating the physical structure of a vending machine that may utilize consumer profile information received from a user device to alter a vend transaction according to one embodiment of the present disclosure. Vending machine 101 (which may be any of vending machines 101a-101d) includes a cabinet 201 and a service door 202 that, together, define an enclosure. In the exemplary embodiment illustrated, the service door 202 is pivotally mounted to the front of the cabinet 201 and extends all the way across the front face of the vending machine 101. In alternate designs, the service door may extend only part way across the front of the vending machine, or may be formed in two portions (of equal or unequal sizes) that swing open in opposite directions.

In the exemplary embodiment illustrated in FIG. 2, the service door 202 includes a transparent panel 203 allowing the consumer to see products stocked within the enclosure of cabinet 201 and available for vending. Service door 202 also includes a customer user interface 204, illustrated as a touch screen liquid crystal display (LCD) display in the exemplary embodiment. A payment system 205 is mounted within the service door 202 and includes one or more of a bill validator, a coin acceptor and/or a credit or debit card reader. The payment system 205 receives currency, coins or other forms of payment from the customer and returns change as necessary. Finally, FIG. 2 depicts an access port 206 to a delivery receptacle mounted within the service door 202 or in the cabinet 201. The access port 206 may have a delivery door or other mechanical system (e.g., rotatable delivery receptacle open on one side) for controlling or restricting access by the customer into the delivery receptacle, the interior of the vending machine, or both. Those skilled in the art will recognize that in some vending machines, particularly helical coil snack vending machines, the access port 206 may be located near the bottom of the vending machine and extend across most of the width of the machine, below the transparent panel 203 (or, alternately, a large liquid crystal display selectively presenting images of products available for vending or advertisements in place of transparent panel 203). Other vending machines, in particular beverage vending machines, have X-Y product retrieval and delivery mechanisms and a glass front or large liquid crystal display, but may include an access port 206 to the side as shown in FIG. 2, at a height convenient to the customer for product retrieval without bending over.

Those skilled in the art will recognize that the complete structure of the network 100, the vending machine 101 and the user device 106 is not depicted in the drawings, and the complete details of the structure and operation of the network 100, vending machine 101 and the user device 106 are not described herein. Instead, for simplicity and clarity, only so much of the structure and operation of a suitable network, vending machine and user device as is unique to the present disclosure or necessary for an understanding of the present disclosure is depicted and described.

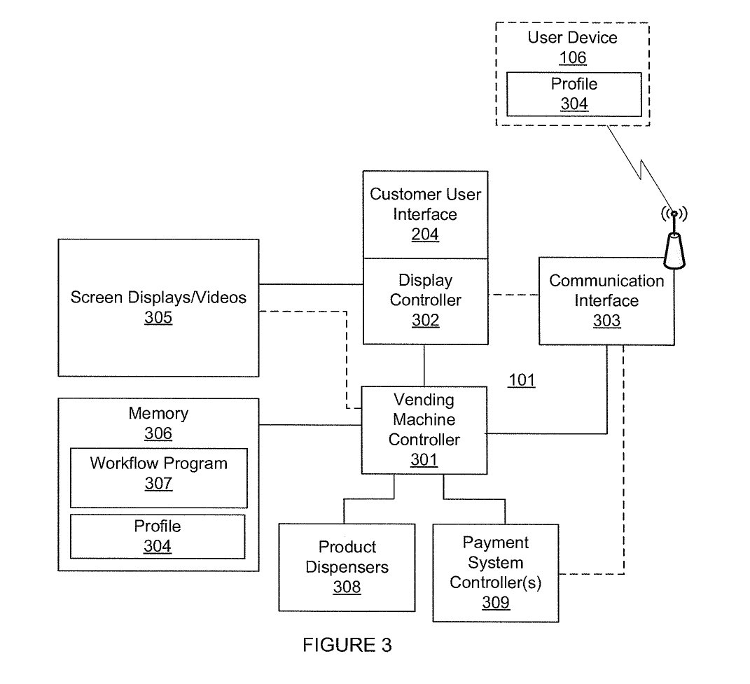

FIG. 3 is a block diagram of selected electrical and electronic components forming at least part of the control system within the vending machine of FIG. 2. Vending machine 101 includes a programmable vending machine controller (VMC) 301 of the type known in the art. Coupled to and communicating with VMC 301 is a display controller 302 for the customer user interface 204. The display controller 302 renders content for display on the customer user interface 204 and detects customer contact with the touch screen for the customer user interface 204, to identify customer selections. Suitable touch-screen display devices and the associated controllers for use as customer user interface 204 and display controller 302 are known in the art.

VMC 301 is also coupled to and communicates with a communication interface 303 enabling data transfer to external devices, such as a handheld computer, a network operations center or another vending machine. Communication may be by wireless data transfer and/or Internet communication or through an access port (e.g., Universal Serial Bus or “USB”) provided in the vending machine 101, as known in the art. Communication with devices external to the vending machine 101 allows for retrieval of collected operational statistics, for update of the programming of the vending machine 101 or download of the operational status of various subsystems, or for the coordinated and common operation of multiple vending machines. In addition, communication interface 303 provides the wireless communications with user device 106, shown in phantom in FIG. 3 since it does not form part of the vending machine 101. However, profile information 304 stored within user device 106 and received by vending machine 101 from user device 106 is employed to personalize one or more vend transactions as described below.

At least the display controller 302 and optionally also the VMC 301 are coupled to and communicate with a memory 305 containing the screen displays and/or videos rendered on the customer user interface 204 during a vend transaction and between transactions. Vending machine controller 301 is also coupled to or includes another memory 306 storing a workflow program 307 for controlling a vend process. While depicted as separate from VMC 301, memory 306 may actually be implemented within the same integrated circuit as VMC 301. As noted, memory 306 stores the workflow program 307 used to control the vending machine's operations during a vend transaction. Memory 306 also stores, at least temporarily during a vend transaction, customer profile information 304 received from the user device 106 via a wireless (e.g., NFC of Bluetooth) data exchange, and used by workflow program 307 to alter the vend transaction initiated by the consumer. These aspects of the vending machine 101 are described in further detail below.

Vending machine controller 301 is also coupled to and communicates with one or more product dispensers 308 (e.g., helical coils or an X-Y product retrieval mechanism) and controller(s) 309 for payment systems 205 such as any combination of a coin mechanism, a bill validator or recycler, and a magnetic stripe card reader. VMC 301 receives signals from and/or issues commands or instructions (control signals) to direct the operation of product dispensers 308 and payment system controllers 309 during vend transactions, to receive payment, dispense a selected product, and dispense any change as necessary. Controllers 309 communicate with VMC 301 and other subsystems within or external to vending machine 101 via a National Automatic Merchandising Association (NAMA) multi-drop bus (MDB), a Data Exchange (DEX) protocol communications channel, or both.

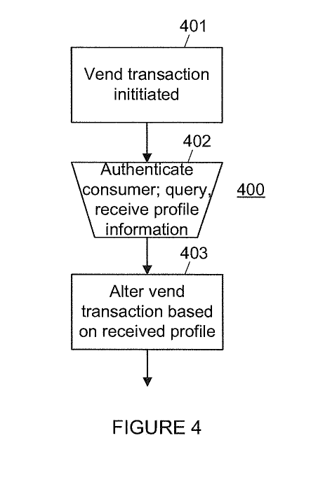

FIG. 4 is a high level process flow diagram for a portion of a vend transaction employing consumer profile information according to one embodiment of the present disclosure. The process 400 is controlled by workflow program 307 and performed within vending machine 101 by execution of the workflow program on the VMC 301. In operation, the network 100, the vending machine 101 and the user device 106 interoperate to allow consumer profile information stored on the user device to be employed to personalize the customer experience for a vend transaction at the vending machine.

The consumer carrying the user device 106 initiates a transaction with the vending machine 101, by touching a portion of the customer user interface 204, for example. The VMC 301 searches for wireless enabled devices within communication range of communication interface 303 using one or more pre-defined or dynamically selected wireless communications protocols. Thus, for example, the communication interface 303 may sequence through a series of wireless communications protocols (NFC, Bluetooth, etc.) seeking to establish communications with a nearby user device. To avoid delaying the vend transaction, the search for nearby user devices may actually be performed prior to the consumer initiating a vend transaction, with the communications interface 303 continuously or periodically seeking to identify user devices within communications range and maintaining an updated list of such devices.

In response to identifying or having previously identified one or more such devices, the vending machine 101 may seek to “authenticate” the consumer—that is, verify that a specific user device belongs to the consumer. Those skilled in the art will recognize that such authentication is necessary to avoid using information from the user devices of bystanders or passersby rather than the user device 106 belonging to the consumer engaged in a vend transaction. For example, a list of the names or “tags” identifying various user devices (e.g., “Bill's iPhone” and/or “KittyCat0101”) may be displayed on the customer user interface 204 together with a prompt for the consumer to select one of the names or tags, followed by an invitation for the consumer to enter a personal identification number (PIN) that may be used by vending machine to authenticate that the selected user device is actually possessed by the consumer engaged in the vend transaction. Alternatively, the vending machine 101 may transmit a request to one or more user devices within communications range, selected based on proximity or other criteria, asking the user to confirm their identify by actuating a physical or virtual (user interface) button on the user device. Such authentication would be inherent and/or necessary, for example, to use of user device 106 to authorize payment on a credit or debit account, and therefore should not be seen by the consumer as unduly delaying the vend transaction.

Once the vending machine 101 has authenticated user device 106 as being possessed by the consumer engaged in the current vend transaction (or as part of the authentication process), the vending machine 101 receives consumer profile information 304 from the user device 106. The vending machine 101 may need to request the consumer profile information 304 or otherwise initiate the transfer, or the user device 106 may simply “push” such information to the vending machine 101 during authentication. In one embodiment, the particular consumer profile information 304 that is received by vending machine 101 from user device 106 may be controlled or limited (at least to some extent) by the consumer owning the user device 106. For example, the consumer may specify that only relevant medical information (food allergies, medical conditions such as diabetes) may be communicated by user device 106 to vending machine, but not personal (name, residence address, phone number, etc.) or demographic (age, gender, race) information. Notably, in instances where the user device 106 is being employed to authorize payment for the vend transaction from a credit or debit account, transfer of at least some personal information will be necessary. In another embodiment, the consumer may be prompted to permit detailed consumer profile information to be communicated to the vending machine 101 from the user device 106, perhaps in exchange for or encouraged by the prospect of a discount or loyalty program rewards points.

In still another embodiment, limited information that the consumer has authorized to be transferred from the user device 106 to the vending machine 101 may be leveraged by the vending machine 101 upon accessing servers 103 and/or 104. For instance, disclosure of a loyalty program identifier by the consumer in order to claim loyalty program rewards points for the vend transaction may be used to access a detailed stored profile from rewards server 103 and/or a transaction history from customer history server 104. As another example, a phone number for the user device 106 communicated to the vending machine during authentication may be compared to public information within the social media (Facebook, Google+) profiles of individuals who have “checked in” to a facility containing the vending machine 101 (e.g., an airport terminal, shopping mall, hotel, etc.), and additional information gleaned from the consumer's social media profile upon determining a match.

Once consumer profile information 304 is received from user device 106 by vending machine 101 (and supplemented in any of the various manners described above or using similar methods), the vend transaction 403 is altered by the workflow program 307 based upon the received consumer profile information 304 (where “based upon” includes altering the vend transaction in response to “supplemental” information accessed or derived using the received consumer profile information 304). For example, product selections containing food allergens (peanuts, gluten) for the consumer may blocked or disabled for the duration of the vend transaction. Alternatively, if a consumer's purchase history reveals a fondness for candy with, for example, caramel, the consumer might be offered a discount on purchase of a Kit Kat Caramel candy bar. As another example, if the consumer profile information 304 indicates that the consumer is a minor authorized to use his/her parent's credit or debit account for the vend transaction, parental controls such as type of snacks, number of snacks per day, and/or timing of snacks during the day (e.g., one snack less than 150 calories after 3:00 pm and before 7:00 pm) may be enforced by the workflow program 307. Of course, the consumer might also be prompted to redeem loyalty program rewards points within the vend transaction, or encouraged to purchase multiple items in exchange for “bonus” loyalty program rewards points.

The present disclosure allows consumer profile information to be employed in vending and other unattended retail transactions where processing and data storage resources are constrained, by receiving the consumer profile information (or an identifier or other index allowing access to remotely stored consumer profile information) from a user device carried by the consumer. Transaction personalization similar to that found in other automated retail purchasing systems (such as Internet sales) may thus be implemented within vending machines, without addition of expensive processing and data storage resources and using existing or slightly modified communications functionality.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A vending machine system for using consumer profile information, comprising:
a communications interface within a vending machine configured to receive consumer profile information from a user device via a wireless communications protocol in connection with a vend transaction; and
a controller within the vending machine configured to alter a work flow within the controller for the vend transaction based on at least a portion of the consumer profile information received from the user device.

2. The vending machine system according to claim 1, wherein the portion of the consumer profile information includes medical information regarding a purchaser for the vend transaction.

3. The vending machine system according to claim 2, wherein the controller is configured to disable certain product selections for the vend transaction that would otherwise be available based on the portion of the consumer profile information received at the communications interface.

4. The vending machine system according to claim 3, wherein the medical information includes food allergies and the controller is configured to disable product selections for products available from the vending machine containing allergens corresponding to the food allergies.

5. The vending machine system according to claim 1, wherein the portion of the consumer profile information includes information regarding parental controls established for a purchaser for the vend transaction.

6. The vending machine system according to claim 5, wherein the controller is configured to prevent vend transactions by a purchaser based on the portion of the consumer profile information received at the communications interface.

7. The vending machine system according to claim 6, wherein the parental control information includes at least one of a type of snacks that the purchaser is precluded from purchasing, a characteristic of snacks that the purchaser is permitted to purchase, a number of snacks per day that the purchaser is permitted to purchase, and timing during the day of snack purchases that the purchaser is permitted to make, and wherein the controller is configured to prevent vend transactions conflicting with the parental control information.

8. The vending machine system according to claim 5, wherein the controller is configured to disable certain product selections for the vend transaction that would otherwise be available based on the portion of the consumer profile information received at the communications interface.

9. The vending machine system according to claim 1, wherein the portion of the consumer profile information includes a purchase history for a purchaser for the vend transaction.

10. The vending machine system according to claim 9, wherein the controller is configured to offer a discount on selected products available for purchase from the vending machine based on the portion of the consumer profile information received at the communications interface.

11. A method for using consumer profile information during a vend transaction, comprising:
receiving consumer profile information from a user device at a communications interface within a vending machine via a wireless communications protocol in connection with a vend transaction; and
altering a work flow within a controller for the vending machine for the vend transaction based on at least a portion of the consumer profile information received from the user device.

12. The method according to claim 11, wherein the portion of the consumer profile information includes medical information regarding a purchaser for the vend transaction.

13. The method according to claim 12, wherein the controller work flow is altered to disable certain product selections for the vend transaction that would otherwise be available based on the portion of the consumer profile information received at the communications interface.

14. The method according to claim 13, wherein the medical information includes food allergies and product selections for products available from the vending machine containing allergens corresponding to the food allergies are disabled in the controller work flow.

15. The method according to claim 11, wherein the portion of the consumer profile information includes information regarding parental controls established for a purchaser for the vend transaction.

16. The method according to claim 15, wherein the controller work flow is altered to prevent vend transactions by a purchaser based on the portion of the consumer profile information received at the communications interface.

17. The method according to claim 16, wherein the parental control information includes at least one of a type of snacks that the purchaser is precluded from purchasing, a characteristic of snacks that the purchaser is permitted to purchase, a number of snacks per day that the purchaser is permitted to purchase, and timing during the day of snack purchases that the purchaser is permitted to make, and wherein the controller work flow is altered to prevent vend transactions conflicting with the parental control information.

18. The method according to claim 15, wherein the controller work flow is altered to disable certain product selections for the vend transaction that would otherwise be available based on the portion of the consumer profile information received at the communications interface.

19. The method according to claim 11, wherein the portion of the consumer profile information includes a purchase history for a purchaser for the vend transaction.

20. The method according to claim 19, wherein the controller work flow is altered to offer a discount on selected products available for purchase from the vending machine based on the portion of the consumer profile information received at the communications interface.
